(19) United States
(12) Patent Application Publication
(10) Pub. No.: US 2018/0136895 A1
(43) Pub. Date: May 17, 2018

(54) VIDEO WINDOW DISPLAY FOR VEHICLES

(71) Applicant: Chamar Harris, Florissant, MO (US)

(72) Inventor: Chamar Harris, Florissant, MO (US)

(21) Appl. No.: 15/807,313

(22) Filed: Nov. 8, 2017

Related U.S. Application Data
(60) Provisional application No. 62/422,583, filed on Nov. 15, 2016.

(51) Int. Cl. G06F 3/14; B60R 11/02

(52) U.S. Cl. CPC G06F 3/1446; B60R 11/0229; G06F 3/04845; H04R 2499/13; H04R 2420/07

(57) ABSTRACT

The present invention relates to a video window display system for vehicles which enable providing a thin transparent display which is visible from the exterior of the vehicle enabling other drivers, pedestrians or the combination thereof to see the graphics shared on the surface of the vehicle window.

### CROSS REFERENCE TO RELATED APPLICATIONS

This application claims priority from U.S. Patent Application Ser. No. 62/422,583, entitled “VIDEO WINDOW DISPLAY FOR VEHICLES”, filed on 15 Nov. 2016. The benefit under 35 USC § 119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates to a video window display system for vehicles. More specifically, the present invention relates to a video window display system for vehicles which enables providing graphics to be displayed on the vehicle window glass for advertisement, communication or decoration purposes.

### BACKGROUND OF THE INVENTION

Vehicle glass includes windscreens, side and rear windows, and glass panel roofs on a vehicle. Side windows glass of the vehicles are conventionally used for safety and protection from external environment but are also used for displaying graphics for advertisement or decoration purpose.

Conventionally used graphics get attached to the vehicle windows glass and are made of such material that the user is unable to change the content displayed. In a situation if the user wishes to change the content displayed on vehicle windows glasses he/she have remove the graphics which causes inconvenience to the user.

Therefore, there exists a need for graphics with creative and innovative displays which are controlled remotely and will enable the user to share or upload images or video onto the vehicle window glass, share important information, or upload customized designs for their vehicle to enhance the still appearance of the car glasses.

### Definitions

Unless stated to the contrary, for the purposes of the present disclosure, the following terms shall have the following definitions:

A printed circuit board (PCB) mechanically supports and electrically connects electronic components using conductive tracks, pads and other features etched from copper sheets laminated onto a non-conductive substrate.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

A client is a piece of computer hardware or software that accesses a service made available by a server. The server is often (but not always) on another computer system, in which case the client accesses the service by way of a network. The term applies to programs or devices that are part of a client-server model.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

A gateway is a link between two computer programs or systems such as Internet Forums. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

An operating system (OS) is software that manages computer hardware and software resources and provides common services for computer programs. The operating system is an essential component of the system software in a computer system. Application programs usually require an operating system to function.

A server is a running instance of an application (software) capable of accepting requests from the client and giving responses accordingly. Servers can run on any computer including dedicated computers, which individually are also often referred to as “the server”.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

A “User” is any person registered to use the computer system executing the method of the present invention.

A “web application” or “web app” is any application software that runs in a web browser and is created in a browser-supported programming language (such as the combination of JavaScript, HTML and CSS) and relies on a web browser to render the application.

### SUMMARY OF THE INVENTION

In order to overcome the above mentioned problem the present invention provides a flexible video window display system installed on the vehicle window glass which enables a user to stream videos and images with the associated computational implemented method of the video window display system.

The at least one user willing to display graphics is enabled to install the video window display system on the exterior side of the window of his/her vehicle. Herein the at least one user is provided with a remote module with installed computational implemented method to control the various display onto the window of the vehicle via video window display system. The flexible display can be used on the exterior or interior of the glass, but due to environmental factors, in a best mode it is recommended to be installed on the exterior side of the window.

Once the installation of the video window display system onto the exterior side of a window of the vehicle is complete, the at least one user is enabled to choose the graphics to be delivered. Herein the computational implemented method installed onto the remote module of the video window display system enables the at least one user to launch third party computational implemented method on the various window glasses of the vehicle.

Therefore, the at least one user is enabled to firstly select the window glass of his/her choice and launch any computational implemented method, with any content that is displayed exclusively on the remote device and also shown on the vehicle window glass.

Herein, the window glasses of the vehicle function as a paired auxiliary display system with the computational implemented method functioning as the display control board. Also the computational implemented method provides various modification options for the display item over the thin display that is the at least one user is enabled to modify the color, size, intensity, brightness of the displayed items via various options present on the UI of the remote module.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIGS. 1a and 1b illustrate a vehicle equipped with the video window display of the present invention in a transparent state and in an active display state.

FIG. 2 is a flow chart illustrating the method of operation and process of the present invention.

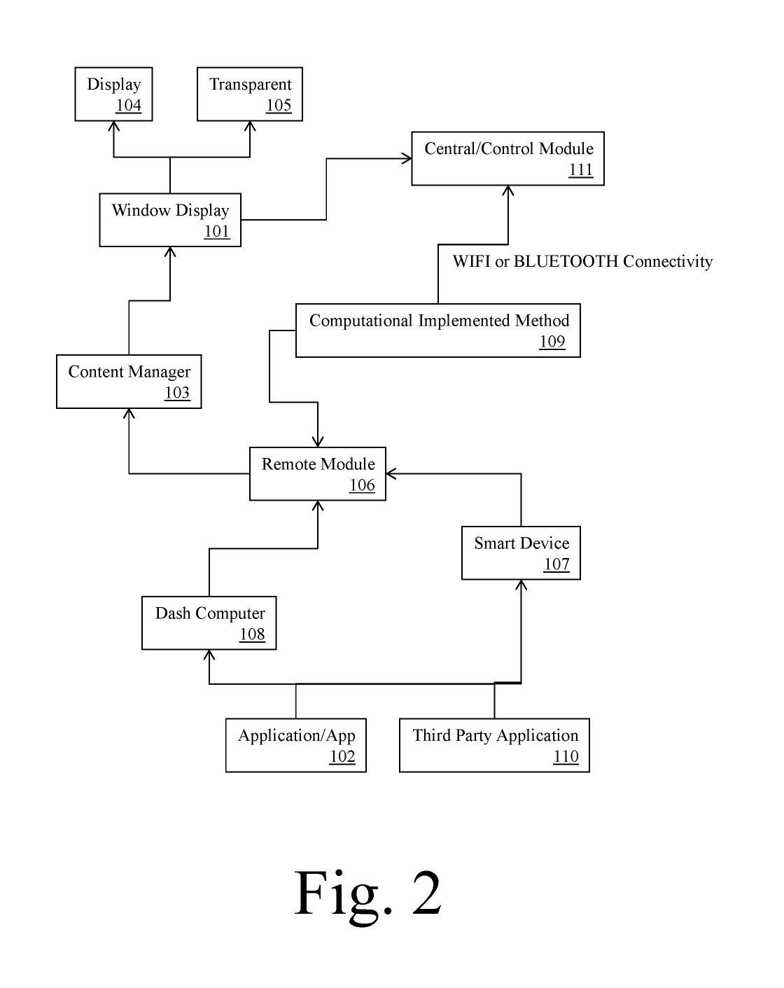

FIG. 3 is a flow chart illustrating the physical components of the present invention and their connectivity.

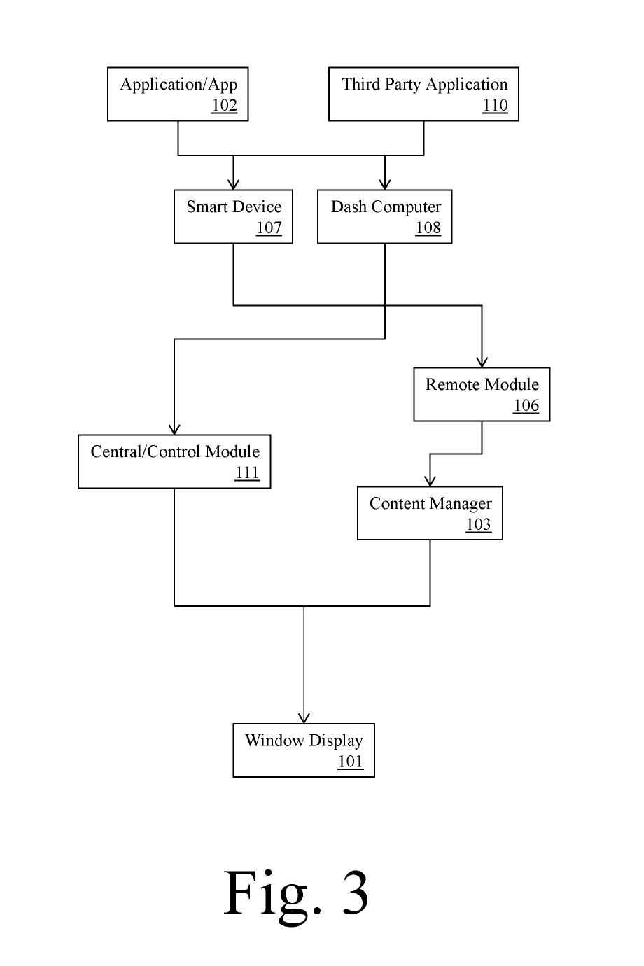

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

References to “one embodiment,” “at least one embodiment(s),” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

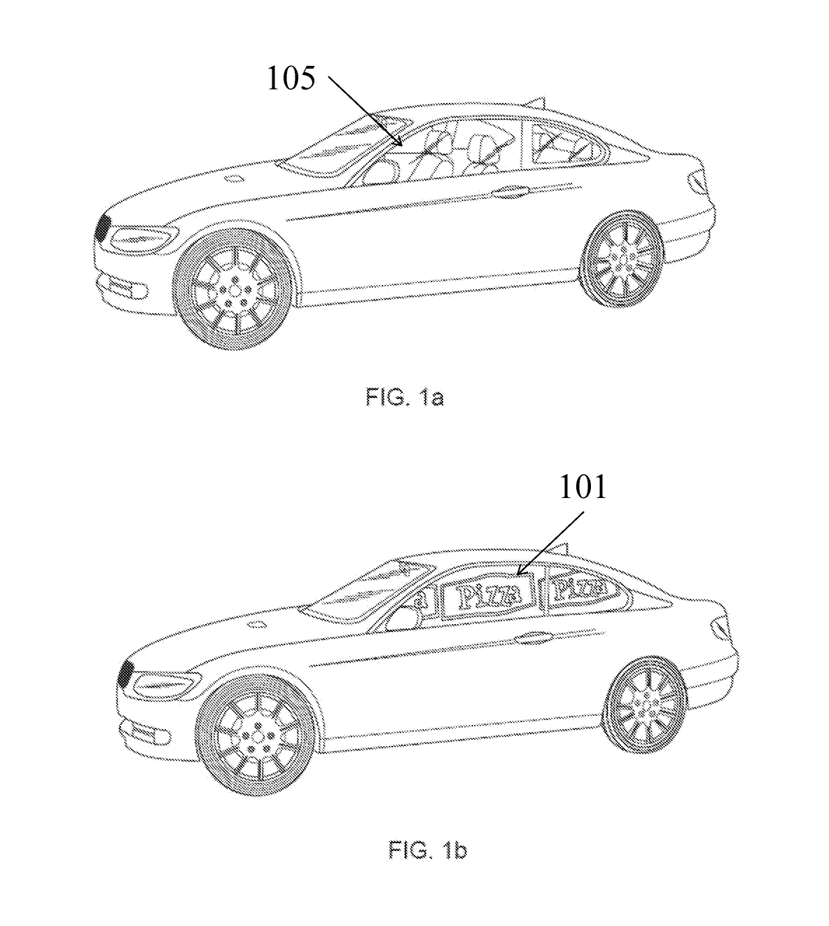

The window display 101 is controlled by BLUETOOTH technology via a content management application/app 102 from a cell phone or smart device using the content manager 103 to stream content from an application/app 102 to the window display 101 on the car/vehicle windows as illustrated in FIG. 1. Full color graphics, photos, animations, and text can all be displayed 104 across a vehicles windows as shown in FIG. 1b. The display 104 shows up vividly when in use and is completely transparent 105 when deactivated as shown in FIG. 1a.

The video window display system is enabled to provide a flexible window display 101 for the vehicle window installed on exterior of vehicle allowing a user to stream videos and images from associated applications 102 comprises: A thin display that is transparent in nature 105; a remote module 106, wherein the remote module 106 is either a smart device 107 or a dash computer 108, and an computational implemented method 109 enabled to run on the remote module 106 associated with the video window display system.

The video window display system herein is a flexible display system installed at the exterior side of a window of a vehicle enabling the at least one user to stream videos and images via associated application or software onto a window of the vehicle. The vehicle windows herein are outfitted with a type of thin display called a video window display system that is transparent in nature.

The transparent display for vehicles is an exceptionally powerful way to advertise, inform, or make a statement with a vehicle. The present invention is not only appealing to business owners but even promoters, street team marketers, or anyone who wants to bring their voice to the road. Small business owners are expected to make extensive use of the transparent display of the present invention to promote themselves amongst other drivers.

The video window display system is visible from the exterior of the vehicle allowing other drivers, pedestrians or the combination thereof to see what the at least one user chooses to share on the surface of the vehicle windows. The at least one user herein is also enabled to control the display 101 via remote module 106, wherein the remote module 106 is either a smart device 107 or a dash computer 108.

The computational implemented method 109 associated with the video window display system enables the at least one user to launch third party application 110 on the various windows of the vehicle, for example the at least one user is enabled to select the side window and launch a third party application 110 such as YOUTUBE, with any content that is normally displayed exclusively on the device 107/108 shown on the window display 101 as well. In this way the windows of the vehicle function as a paired auxiliary display system to the third party application 110 with the computational implemented method 109 functioning as the display control board.

In another example, the present inventions uses the cars audio system through the dash computer 108, running or executing a music streaming application opened inside the dash computer 108 like (PANDORA) and communicating with the content manager 103 or the computational implemented method 109 could be displayed across the window display 101 with custom skins or live wallpapers while streaming music through the cars audio system via wireless communication such as WIFI or BLUETOOTH.

When the video display system is launched/activated there is a chime, jingle, or sound effect specific to the video display system is audible through the vehicles infotainment systems or car audio.

The computational implemented method 109 also includes preloaded animations, transition effects, or games. Herein the at least one user's is also enabled to choose and upload still images onto the vehicle window and have a custom livery designed or installed for their vehicle to enhance the appearance of the vehicle.

For example, perhaps the vehicle is used for commercial delivery, the at least one user is enabled to choose the display logo for business purposes providing the item to be delivered and the display may be turned off when the vehicle is not being used for delivery as shown in FIGS. 1a and 1b. The video window display system is either integrally coupled or is removably coupled to the vehicle.

Other users on the roadway using the same computer implemented method 109 may also connect to one another via their smart devices 107 and share content across the video window display screens 101 or download content from another user in their vicinity.

In the preferred embodiment the at least one user willing to display graphics is enabled to install the video window display system on the exterior side of the window of his/her vehicle. Herein the at least one user is provided with a remote module 106 with installed computational implemented method 109 to control the various displays 101 on the window of the vehicle via video window display system.

The flexible window display used would have to be hard wired to a central/control module 111 that can then communicate with said computational implemented method 109, whether it be WIFI, or BLUETOOTH.

In a hands-free embodiment, speech command would enable a user to give one or more verbal commands to the remote module 106 or the central/control module 111 and then the computational implemented method 109 associated with the application 102 executes the verbal command that was given.

Once the installation of the video window display system onto the exterior side of a window of the vehicle is complete, the at least one user is enabled to choose the graphics to be delivered. Herein the computational implemented method 109 installed onto the remote module 106 of the video window display system enables the at least one user to launch third party computational implemented method 109 as well on the various window glasses of the vehicle.

Therefore, the at least one user is enabled to firstly select the window glass of his/her choice and launch any video streaming computational implemented method 109, with any content that is displayed exclusively on the remote device 107/108 and also shown on the vehicle window glass.

Herein, the window glasses of the vehicle function as a paired auxiliary display system with the computational implemented method 109 functioning as the display control board. Also the computational implemented method 109 provides various modification options for the display item over the thin window display 101 that is the at least one user is enabled to modify the color, size, intensity, brightness of the displayed items via various options present on the graphical user interface (GUI) of the remote module 106.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A video window display system, comprising
a flexible display;
a vehicle with one or more windows;
the flexible display installed on an exterior window of the vehicle;
a remote module providing one or more associated applications;
a receiving and control module connected to the flexible display; and
the remote and receiving and control modules enabling a user to stream videos and images from associated applications.

2. The video window display system of claim 1, wherein
the flexible display is transparent in nature.

3. The video window display system of claim 1, wherein
the remote module is either a smart device or the vehicle's dash computer.

3. The video window display system of claim 1, wherein
the remote module is further comprised of a computational implemented method enabled to run on the remote module associated with the video window display system.

4. The video window display system of claim 1, wherein
the flexible display system is installed on the exterior side of a window of a vehicle enabling an at least one user to stream videos and images via associated application or software onto a window of the vehicle.

5. The video window display system of claim 4, wherein
the video window display system is visible from the exterior of the vehicle allowing other drivers, pedestrians or the combination thereof to see what the at least one user chooses to share on the surface of the vehicle windows; and
the at least one user herein is also enabled to control the display via remote module, wherein the remote module is either a smart device or a dash computer.

6. The video window display system of claim 1, wherein
the computational implemented method associated with the video window display system enables the at least one user to launch a third party application on the various windows of the vehicle.

7. The video window display system of claim 6, wherein
the at least one user is enabled to select the side window and launch an application, with any content that is normally displayed exclusively on the device shown on the window as well.

8. The video window display system of claim 6, wherein
the windows of the vehicle function as a paired auxiliary display system with the computational implemented method functioning as the display control board.

9. The video window display system of claim 1, wherein
the computational implemented method also includes a preloaded animations, transition effects, or games.

10. The video window display system of claim 9, wherein
the at least one user's is also enabled to choose and upload still images onto the vehicle window and have a custom livery designed or installed for their vehicle to enhance the appearance of the vehicle.

11. The video window display system of claim 1, wherein
the video window display system is either integrally coupled or is removably coupled to the vehicle.

12. The video window display system of claim 1, wherein
other users on the roadway using the same computer implemented method connect to one another via their smart devices; and
share content across the video window display screens or download content from another user in their vicinity.

13. The video window display system of claim 1, wherein
the at least one user willing to display graphics is enabled to install the video window display system on the exterior side of the window of his/her vehicle;
the at least one user is provided with a remote module with installed computational implemented method to control the various displays on the window of the vehicle via video window display system;
once the installation of the video window display system onto the exterior side of a window of the vehicle is complete, the at least one user is enabled to choose the graphics to be delivered; and
the computational implemented method installed onto the remote module of the video window display system enables the at least one user to launch third party computational implemented method as well on the various window glasses of the vehicle.

14. The video window display system of claim 13, wherein
the at least one user is enabled to firstly select the window glass of his/her choice; and
launch any video streaming computational implemented method, with any content that is displayed exclusively on the remote device and also shown on the vehicle window glass.

15. The video window display system of claim 14, wherein
the window glasses of the vehicle function as a paired auxiliary display system with the computational implemented method functioning as the display control board.

16. The video window display system of claim 15, wherein the computational implemented method provides various modification options for the display item over the thin display that is the at least one user is enabled to modify the color, size, intensity, and brightness of the displayed items via various options present on the graphical user interface (GUI) of the remote module.

17. The video window display system of claim 3, wherein
a vehicle's audio system, through the dash computer is running or executing a music streaming application opened inside the dash computer; and
the dash computer communicating with a content manager to display, across the window display, one or more custom skins or live wallpapers while streaming music through the cars audio system via wireless communication.

18. The video window display system of claim 3, wherein
a vehicle's audio system, through the dash computer is running or executing a music streaming application opened inside the dash computer; and
the dash computer communicating with the computational implemented method to display, across the window display, one or more custom skins or live wallpapers while streaming music through the cars audio system via wireless communication.

19. The video window display system of claim 17, wherein
when the video display system is launched/activated there is a chime, jingle, or sound effect specific to the video display system is audible through the vehicles infotainment systems or car audio.

20. The video window display system of claim 1, wherein
the flexible display can be used on the exterior or interior of the glass.
